(19) United States
(12) Patent Application Publication
(10) Pub. No.: US 2008/0123640 A1
(43) Pub. Date: May 29, 2008

(54) METHOD FOR DISCOVERING OUTBOUND SIP PROXY SERVER

(76) Inventors: RAVIDEEP BHATIA, West Dundee, IL (US); Michael F. Coulas, Buffalo Grove, IL (US)

Correspondence Address: MOTOROLA INC, 600 NORTH US HIGHWAY 45, W4 - 39Q, LIBERTYVILLE, IL, 60048-5343, US

(21) Appl. No.: 11/533,461

(22) Filed: Sep. 20, 2006

(51) Int. Cl. H04L 12/56

(52) U.S. Cl. 370/389

(57) ABSTRACT

Disclosed is a SIP client having a session initiation protocol module. A router that is capable of communicating with the SIP client, the router having a closest anycast IP server module. A SIP proxy server having an anycast address and a unicast address replacement module, the unicast address replacement module capable of replacing the anycast IP address of a received IP packet, that includes a session initiation protocol request message, with a unicast IP address of the SIP proxy server.

### FIELD OF THE DISCLOSURE

This disclosure relates generally to outbound session initiation protocol proxy server discovery.

### BACKGROUND OF THE DISCLOSURE

Wireless data continues to proliferate to wireless networks as well as wired or optical networks. Additionally, data rates continue to increase in all mediums. Mobile stations, through their roaming nature of operation, access data networks from multiple nodes such as base stations, access points and the like. Different communication types require servers configured to transfer the data efficiently and effectively in accordance with the type of communication. For example, voice over IP services require servers that can manage that data that provide a quality of service sufficient for voice communications. Multimedia such as streaming audio and video requires servers that can exchange data at a rate to maintain glitch free streaming. Special servers are coupled to and distributed thought the network to accommodate and enable access to these and other services. A device connected to a fixed point can couple to the special server by provisioning on the device a particular address desired such as a Domain Name or IP address or alternatively may obtain these through dynamic host configuration protocol (DHCP). These types of addressing protocols however do not lend themselves well to mobile devices. Provisioning an address will not allow a first hop proxy server to be found in the visited network in the case where the device is roaming and DHCP is a complex protocol requiring support in both the device and the network. Additionally, DHCP is also problematic as this protocol requires the mobile station (user agent) to support DHCP capability. Mobile stations may not have this capability and, when they do, this requires specific options for location SIP proxy servers which may not be supported by the DHCP capability on the mobile station or the DHCP service in the network.

Further, for multimedia network data transfers, the session initiation protocol (SIP) is an application layer control protocol that is used to establish, modify and terminate multimedia sessions. Use of the SIP requires a SIP proxy server and prior to initiating a SIP transaction, an outbound SIP proxy server must be identified to route the SIP signaling data, which is done so by a unicast address of the outbound SIP proxy server.

The various aspects, features, and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows an exemplary network that has a SIP proxy server and a SIP client according to an embodiment.

FIG. 2 shows an exemplary IP data packet that is a SIP request.

FIG. 3 shows an exemplary IP data packet that is a SIP response.

FIG. 4 shows an exemplary flow diagram of one method for discovering the outbound SIP proxy server.

FIG. 5 shows an exemplary flow diagram of another method for discovering the outbound SIP proxy server.

### DETAILED DESCRIPTION

A system and method of discovering an outbound session initiation protocol (SIP) proxy server is disclosed. The system is a communication network comprising a SIP client having a session initiation protocol module. The system also comprises a router that communicates with the SIP client, the router having a closest anycast IP server discovery module. The system further comprises a SIP proxy server that includes a unicast address and which is also configured as an anycast IP server with a SIP proxy server anycast IP address. The SIP proxy server includes a unicast address replacement module. The unicast address replacement module inserts the unicast IP address of the SIP proxy server in a SIP response to the SIP request.

The method of discovering an outbound SIP proxy server comprises sending a SIP request to a SIP proxy server, the message containing a SIP proxy server anycast IP address. Receiving a response message from the SIP proxy server containing a unicast address of the SIP proxy server having the anycast address. The method further comprises sending subsequent SIP requests to the unicast address received.

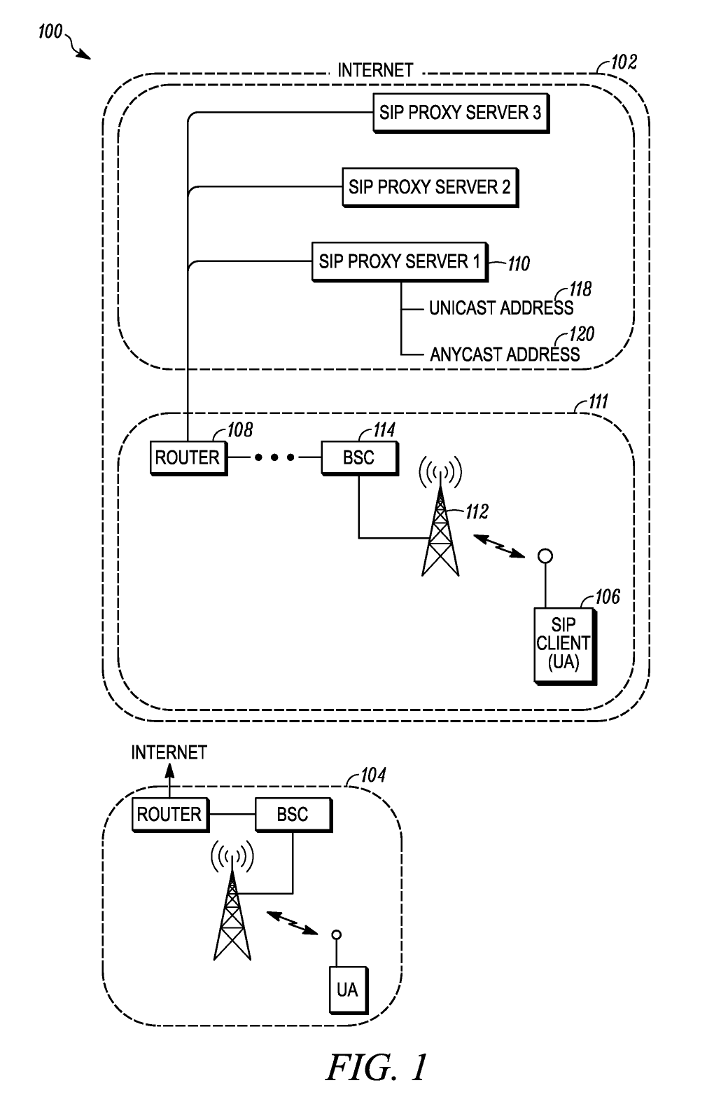

FIG. 1 illustrates a network 100 having a SIP proxy server 110. The network 100 includes two portions, a visited portion 102 and a home portion 104. The network 100 also includes a first SIP client 106, which in this embodiment is a mobile terminal, of a plurality of mobile terminal (not shown for simplicity). The SIP client 106 is located in the visited portion 102 of the network 100. A visited portion of the network is a network or portion of the network in which the SIP client 106 has roamed to or is a network not considered the SIP client's 106 home network 104. The visited portion 102 of the network includes a router 108 and a first session initiation protocol (SIP) proxy server 110 of a plurality of SIP proxy servers 112.

The SIP proxy server 110 has a unicast address 118 and has an IP interface configured with a SIP proxy server anycast address 120. In general, an anycast address is an identifier for a set of interfaces, the interfaces typically belonging to different nodes (e.g. servers). A packet sent to an anycast address is delivered to one of the interfaces identified by that address, i.e., the “nearest” (or closest, as it may also be referred to) one, according to the routing protocols' measure of distance (e.g. one hop, two hops . . . ). The SIP proxy server 110 is configured to receive SIP requests and packets addressed to the anycast address. The SIP client 106, in this embodiment, is a user agent that uses the SIP protocol and the anycast address to exchange information through the SIP proxy server and between the desired final destination.

In this network 100, the SIP client 106 is a wireless communication device (e.g. a cellular telephone) that is configured to communicate with the SIP proxy server 110, i.e. an outbound SIP proxy server through a wireless network 111. The SIP client 106 communicates with a base station 112 of the wireless network 111 which is part of the visited network 102. The base station 112 is coupled to a base station controller 114 which is coupled to a router 108 which may be an internet gateway or the like, and through these entities, the SIP client 106 may couple to the outbound SIP proxy server 116. It should also be noted that the router 108 may be part of the wireless communication network 111, the visited network 102, or there may be a router 108 that is a part of the wireless communication network 111 and in addition thereto a second router that is a part of the internet (not shown) and coupled to the router 108 of the wireless communication network 111. Routers and routing are generally know to those of ordinary skill in the art. Either router may have a closest anycast IP discovery server module to locate an anycast server or a server with an anycast IP address, i.e. the IP proxy server 110. Additionally, there may be a plurality of routers between the wireless communication network 111 and the SIP proxy server 116.

The wireless communication network 111 is a network such as a radiotelephone telephone network of which there are many types including GSM, CDMA, WCDMA or the like, a wireless local area network such as an 802.11x type network, a wireless wide area network such as an 802.16x type network or the like. In these embodiments the networks are wireless.

The SIP client may be a user agent, such as the mobile terminal in this embodiment, or it may be another server such as a SIP proxy server. The user agent may be a mobile terminal a computer, palmtop computer, laptop computer, or the like, all either wired or wireless. The user agent may be a back to back user agent server such as a translation server or a call forwarding server.

Wireless networks allow devices to move (roam) from one network to another in order to provide contiguous service coverage. The network however may also be wired network. A SIP client may be a mobile agent such as a portable computer, or the like, that may connect to the network via wires such as an through an Ethernet connection. In either case, the SIP client has moved from a portion of the network that is considered the home network portion. SIP clients that wish to connect to the internet may do so using the SIP which is an application-layer control protocol. When using the SIP protocol, the SIP client connects to another SIP client using a SIP request that is sent to the closest (first hop) outbound SIP proxy server. The outbound SIP proxy server then routes the messages efficiently between the SIP clients.

Therefore, in this embodiment, the SIP client 106 discovers and then connects to an outbound SIP proxy server 110 by connecting through the base station 112 of the wireless network 111 and through a through the router 108 to the SIP proxy server 110.

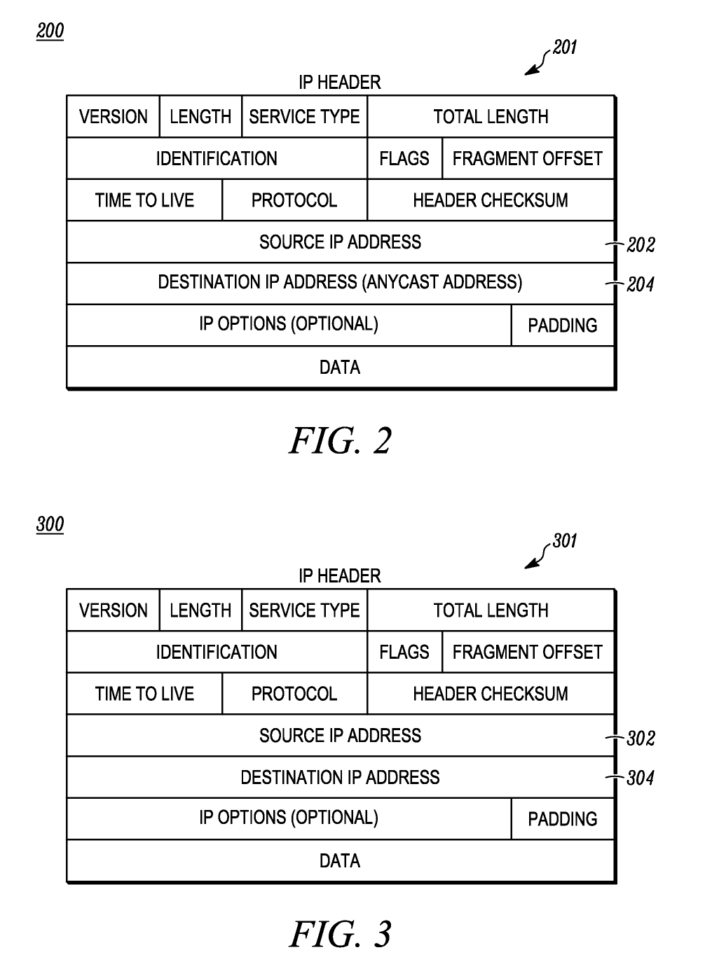

FIG. 2 illustrates an exemplary block diagram of an IP packet 200 that includes a SIP message in the payload. A SIP message may be a SIP request sent from the SIP client or a SIP response sent from the SIP proxy server back to the SIP client. In FIG. 2, the SIP message is a SIP request for discovering a SIP proxy server (in addition to contacting a destination SIP client) wherein the request is sent from a SIP client 106 to the SIP proxy server 106. The SIP response is carried in the IP packet having an IP header 201. In this embodiment, the SIP proxy server, i.e. the outbound SIP proxy server 110, is identified by the anycast address of the SIP proxy server 120. The router 108 in the internet gateway directs the SIP request to the anycast address which is the SIP proxy server. The SIP request may also be referred to as a SIP request message or the like. The IP header is part of the IP packet that carries the SIP message as payload.

The IP header 201 includes inter alia, a Source IP address 202 and a Destination IP address 204. The Source IP address 202 includes the address of the SIP client 106, the client IP address, and the Destination IP address 204 includes the anycast address of the SIP proxy server 110. The router 108 receives the SIP request and routes the request to the anycast address which is the SIP proxy server. The SIP proxy server 110 in this embodiment is the first hop (i.e. outbound) SIP proxy server as determined by the router and serves as the outbound SIP proxy server for the SIP client 106. This SIP proxy server receives the SIP request, the SIP request addresses to the anycast IP address.

In FIG. 3, the SIP message is a SIP response from a SIP proxy server to the user agent 106. The SIP response is carried in the IP packet having an IP header 201. This SIP message 300 is a response to the SIP request 200 sent from the SIP client 106. The SIP response may also be referred to as a SIP response message or the like.

The IP header 301 of the SIP response 301, the Source IP address 302 includes the address of the SIP proxy server, i.e. the unicast IP address, and the Destination IP address 304 includes the address of the SIP client 106. The SIP proxy server 110 has replaced the anycast address used in the SIP request by the SIP client 106 with the unicast IP address of the SIP proxy server. The SIP proxy server generates a SIP response and inserts the unicast address of the SIP proxy server into the source IP address 302 of the IP header. The SIP proxy server 110, in this embodiment, is a first hop (i.e. outbound) SIP proxy server as determined by the network and now serves as the outbound SIP proxy server for the user agent 106. Once the SIP client 106 receives the SIP response from the SIP proxy server 110, the user agent 106 stores the received unicast address 118 and sets the destination address 304 for SIP communications to the unicast address.

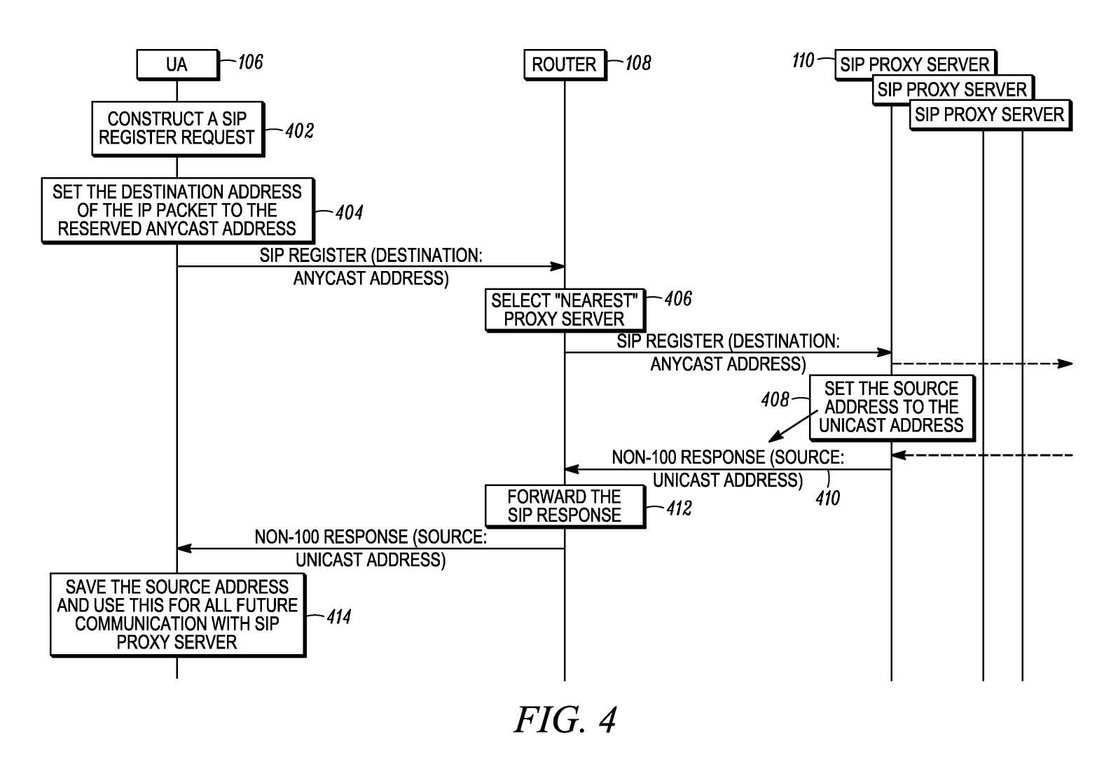

FIG. 4 illustrates an exemplary flow diagram of one method for discovering the outbound SIP proxy server 110. In this embodiment, the SIP client, user agent in this exemplary embodiment, constructs 402 (generates) a SIP REGISTER request (i.e. a SIP request). The destination address of the IP packet, that includes the generated SIP request, is set 404 to the SIP proxy server anycast address. The router which receives the request selects 406 and then sends the SIP request to the anycast address which is configured within the SIP proxy server 110. Once the SIP request is received, the SIP proxy server sets 408 the source address into the unicast address of the SIP proxy server in the SIP response message that is to be sent back to the SIP client 106. The SIP proxy server sends 410 the SIP response in a “non-100” response through the router 412 to the SIP client 106. The SIP client 106 then saves 414 the unicast address from the source field and uses this address for subsequent communications with final destination via the SIP proxy server 110.

Upon receipt of a first SIP request (e.g., SIP REGISTER request) from the SIP client, the SIP proxy server 110 processes with a processor the request and forwards it towards the destination addressed in the Request URI (e.g., the destination could be a SIP user agent, a SIP registrar server, a SIP application server or the like). When the first non-100 trying response is received from the destination, the SIP proxy server forwards it to the SIP client that originated the SIP request. While forwarding the request, the SIP proxy server sets the source address of the IP packet, in which SIP response is carried, to the unicast address (i.e., not the anycast address). This is the interface with which the proxy server wants to receive SIP requests from the SIP clients. In this embodiment, the outbound SIP proxy server is a stateful proxy.

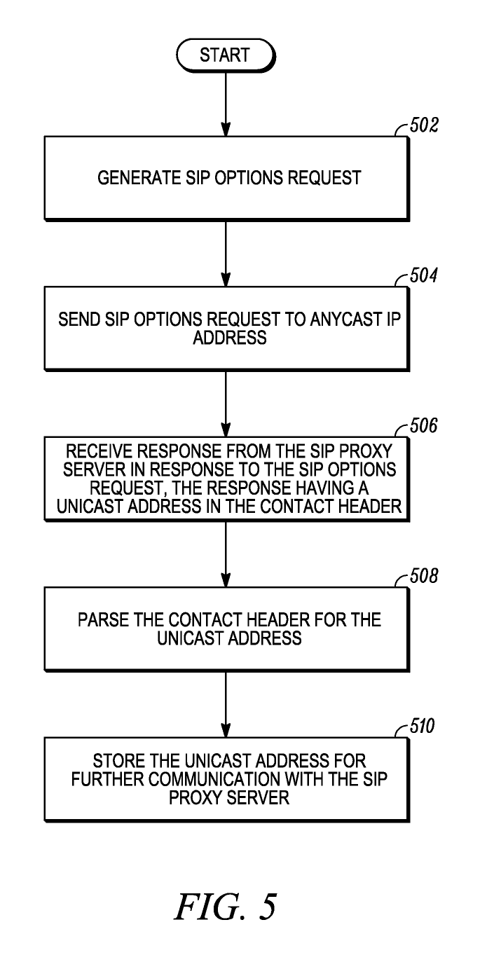

In another embodiment, the method for obtaining the address of an outbound SIP proxy server is based on the use of a SIP OPTIONS Request. FIG. 5 illustrates an exemplary process flow for discovering a SIP proxy server using SIP OPTIONS. In this embodiment, a SIP OPTIONS request is sent from a SIP client to the SIP proxy server using the anycast address; that is, as discussed above, the SIP proxy server has an anycast IP address. The unicast address of the discovered outbound SIP proxy server is returned in the Contact header of the SIP response from the SIP proxy server 110 to the SIP client 106.

In this embodiment, the method allows a SIP client to query a server or another SIP client about that server's or that client's capabilities. This enables a SIP client to discover information about the addressed SIP entity, which in this case is an outbound SIP proxy server that has an anycast address.

In this embodiment, the SIP client 106 using the SIP OPTIONS method to discover the unicast address of an outbound SIP proxy server generates 502 an OPTIONS request, which includes a Request-uniform resource identifier (URI) set, to the SIP proxy server anycast address and the default SIP port. In addition, a Max-Forwards header of the SIP OPTIONS request has a value which is set to 0(zero). This ensures that the SIP proxy server does not forward the request. In this exemplary embodiment, the SIP OPTIONS request would be as follows:

OPTIONS sip:<SIP proxy server anycast address>:5600 SIP/2.0
Via: SIP/2.0/UDP [5555::a:b:c:d]:1357;branch=z9hG4bKnashds7
Max-Forwards: 0
From: <sip:user1_public1@home1.net>;tag=4fa3
To: <sip:<SIP proxy server anycast address>>
Contact: <sip:[5555::a:b:c:d]:1357;
Call-ID: apb03a0s09dkjdfglkj49111
CSeq: 1 OPTIONS
Supported: path, sec-agree
Content-Length: 0

After generating 502 the OPTIONS request, the SIP client 106 sends 504 the request to the anycast address and port specified in the Request URI, i.e., as a result of resolving the address in the Request-URI. When this data packet (i.e. the OPTIONS request) is received by the router of the network, the router 108 will find a single outbound SIP proxy server that is, in this embodiment, nearest to this user and route it to that SIP proxy server. Since the proxy server is listening on the anycast address it will accept the packet and pass it to the SIP layer for processing.

When the SIP proxy server 110 receives an OPTIONS request from the SIP client 106 addressed to the SIP proxy server anycast address and with Max-Forwards set to 0, the SIP proxy server 110 knows that it has to process the request and generate a SIP response to the SIP client. After processing the OPTIONS requests, the proxy server returns a 200 (OK) response to the SIP client listing the capabilities of the server. This response includes one or more Contact headers containing one or more addresses of the proxy server. These addresses can either be the actual unicast IP address (or addresses) of the proxy server or a Fully Qualified Domain Name (FQDN) that resolves to the unicast IP address of the proxy server for example. While sending the response, the SIP proxy server sets the source address in the IP header 201 to the unicast source address of the interface on which the proxy server wants to receive SIP requests from the SIP clients.

SIP/2.0 200 OK
Via: SIP/2.0/UDP [5555::a:b:c:d]:1357;branch=z9hG4bKnashds7
From: <sip:user1_public1@home1.net>;tag=4fa3
To: <sip:<SIP proxy server anycast address>>;tag=5ef4
Call-ID: apb03a0s09dkjdfglkj49111
Contact: <sip:pcscf1.visited1.net:5060>
Contact: <sip:[5555::c:d:e:f]:5060>
CSeq: 1 OPTIONS
Allow: INVITE, ACK, CANCEL, OPTIONS, BYE, MESSAGE,
NOTIFY, PRACK, REFER, UPDATE
Accept-Language: en
Supported: path, sec-agree
Content-Length: 0

When the SIP client 106 receives 506 a 200 (OK) response for the SIP OPTIONS request from the selected SIP proxy server, it parses 508 the Contact header(s) and stores 510 at least one of the contact addresses to be used in the initial route-set of subsequent SIP requests. The outbound SIP proxy server address is typically placed in the topmost Route header of outbound SIP requests. The Route header(s) tells the SIP to route the request via a particular server or servers. The Request-URI addresses the ultimate or final destination.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

As understood by those in the art, a processor executes applications having computer program code to implement the methods described herein. The plurality of embodiments presented herein use processors and computer program code to execute the SIP protocol, whether in the SIP client, SIP proxy server, router, air interface systems and the like. Embodiments include computer program code containing instructions received from tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

We claim:

1. A Network comprising;
a session initiation protocol (SIP) client having a session initiation protocol module that generates a SIP request which includes an anycast IP address;
a router capable of communicating with the SIP client, the router having a closest anycast IP discovery server module; and
a SIP proxy server having a unicast address and an anycast IP address, the SIP proxy server including a unicast address insertion module, to insert the unicast IP address into a SIP response to the SIP client.

2. The apparatus of claim 1, further comprising a wireless communication network that includes a base station which is coupled to the router.

3. The apparatus of claim 2, wherein the SIP client is a wireless communication device that communicates with the wireless communication network.

4. The apparatus of claim 1, wherein the SIP client is a user agent.

5. A method for discovering a session initiation protocol proxy server comprising:
sending a SIP request including an anycast address;
receiving a message from a SIP outbound proxy server including a source unicast address of the SIP proxy server with the anycast address; and
sending subsequent SIP requests to the source unicast address received.

6. The method of claim 5, further comprising an IP data packet that includes an IP header and a data field that carries the SIP request as payload.

7. The method of claim 5, further comprising: inserting, at the SIP client, the anycast address in a destination field of the IP header of the SIP request.

8. A method for SIP proxy discovery comprising;
transmitting from a SIP client an IP packet containing a SIP request to an IP router, the IP router to locate the SIP proxy server, the IP packet including an anycast IP address as the destination address;
receiving from an SIP proxy server having the anycast IP address an IP packet having a unicast address as the source address; and
establishing the unicast address of the SIP proxy server as the address of the SIP proxy server for the SIP client.

9. The method of claim 8, transmitting from a SIP client an IP packet containing a SIP request to an IP router, the IP router to locate the closest SIP proxy server.

10. A method for a SIP OPTIONS request comprising:
addressing a SIP OPTIONS request to an anycast address;
receiving a SIP response to the SIP OPTIONS request, the response having a Contact header that includes a unicast address of the outbound SIP proxy server that serviced the SIP OPTIONS request; and
establishing the unicast address included in the Contact header as the address of the SIP proxy server for the SIP client.

11. The method of claim 10, further comprising, requesting, in the SIP OPTIONS request, the unicast address of the SIP Proxy Server having the anycast address.

12. The method of claim 10, further comprising sending a SIP request having the unicast address to a destination SIP client.

13. A method for discovering a proxy server comprising:
receiving a IP packet from a SIP proxy server, the IP packet including, an address portion consisting of a source address and a destination address, and a payload portion, the payload portion including a SIP response to a SIP request; and
requesting, by the SIP stack, the unicast address, of the source address in the address portion of the IP packet.

14. A method of discovering a SIP proxy server comprising:
receiving a SIP request at a SIP proxy server, the SIP request addresses to an anycast IP address;
generating a SIP response to the SIP request received; and
inserting a unicast address of the SIP proxy server into the SIP response.

15. The method of claim 14, inserting by a unicast address insertion module, the unicast IP address of the SIP proxy server in a source address field of the IP header.

16. The method of claim 14, further comprising forwarding, by the SIP proxy server, the SIP request to the destination addressed in a Request URI.

17. The method of claim 14, further comprising forwarding the SIP response to the SIP client.

18. A method for discovering a SIP proxy server comprising:
sending a SIP request from a SIP client, the SIP request addressed to an anycast address;
receiving the SIP request at a router;
determining the closest anycast IP server having the anycast address received in the SIP request;
forwarding the SIP request to the anycast IP server which is also a SIP proxy server;
generating at the SIP proxy server a SIP response, the SIP response having a unicast address of the SIP proxy server; and
sending the SIP response to the SIP client.

19. The method of claim 18, further comprising: forwarding, by the SIP proxy server, the SIP request, to a destination SIP client.

20. The method of claim 18, wherein the SIP client is a user agent or a sip proxy server.
